(19) United States
(12) Patent Application Publication
(10) Pub. No.: US 2006/0179350 A1
(43) Pub. Date: Aug. 10, 2006

(54) Dynamic marshaling testing

(75) Inventors: Adam Nathan, Kirkland, WA (US); Yasir Alvi, Bellevue, WA (US); Ryan Alexander Dawson, Redmond, WA (US); Christopher Edward Szczepaniak King, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/056,180

(22) Filed: Feb. 10, 2005

(51) Int. Cl. G06F 11/00

(52) U.S. Cl. 714/38

(57) ABSTRACT

Test cases may be dynamically generated for testing interoperability between different execution environments.

### DRAWINGS

The detailed description refers to the following drawings.

FIG. 1 shows a network environment in which examples of dynamic marshaling testing may be implemented.

FIG. 2 shows an example of a testing environment for implementing examples of dynamic marshaling testing.

FIG. 3 shows an example of an auto marshaler in accordance with one or more implementations of dynamic marshaling testing.

FIG. 4 shows examples of method calls made by a target object in accordance with one or more implementations of dynamic marshaling testing.

FIG. 5 shows an example processing flow associated with dynamic marshaling testing implementation.

### DETAILED DESCRIPTION

Dynamic marshaling testing is described herein.

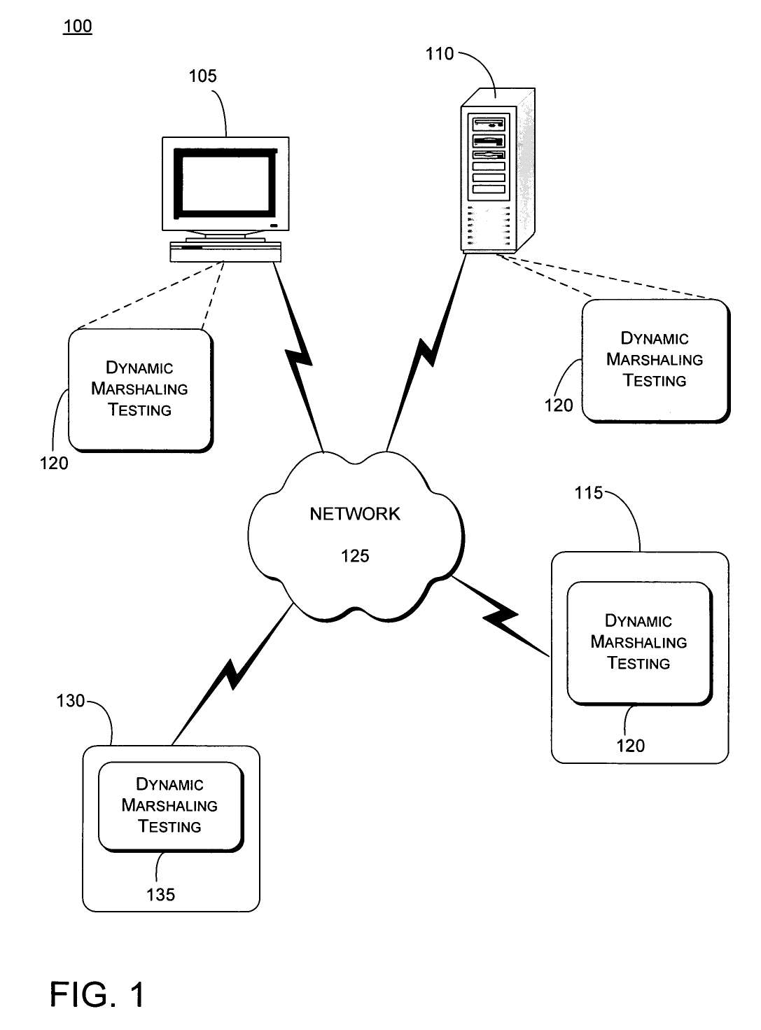

FIG. 1 shows an example network environment in which dynamic marshaling testing may be implemented. However, implementation of dynamic marshaling testing, according to at least one example, is not limited to network environments. Regardless, in FIG. 1, any one of client device 105, server device 110, and “other” device 115 may be capable of implementing dynamic marshaling testing 120, as described herein. Client device 105, server device 110, and “other” device 115 may be communicatively coupled to one another through network 125.

Client device 105 may be at least one of a variety of conventional computing devices, including a desktop personal computer (PC), workstation, mainframe computer, Internet appliance, set-top box, and gaming console. Further, client device 105 may be at least one of any device that is capable of being associated with network 125 by a wired and/or wireless link, including a personal digital assistant (PDA), laptop computer, cellular telephone, etc. Further still, client device 105 may represent the client devices described above in various quantities and/or combinations thereof. “Other” device 115 may also be embodied by any of the above examples of client device 105.

Server device 110 may provide any of a variety of data and/or functionality to client device 105 or “other” device 115. The data may be publicly available or alternatively restricted, e.g., restricted to only certain users or only if an appropriate subscription or licensing fee is paid. Server device 110 may be at least one of a network server, an application server, a web blade server, or any combination thereof. Typically, server device 110 is any device that is the source of content, and client device 105 is any device that receives such content either via network 125 or in an off-line manner. However, according to the example implementations described herein, client device 105 and server device 110 may interchangeably be a sending host or a receiving host. “Other” device 115 may also be embodied by any of the above examples of server device 110.

“Other” device 115 may further be any device that is capable of implementing dynamic marshaling testing 120 according to one or more of the example implementations described herein. That is, “other” device 115 may be any software-enabled computing or processing device that is capable of implementing dynamic marshaling testing for an application, program, function, or other assemblage of programmable and executable code, across an interface between a managed execution environment and an unmanaged execution environment. Thus, “other” device 115 may be a computing or processing device having at least one of an operating system, an interpreter, converter, compiler, or runtime execution environment implemented thereon. These examples are not intended to be limiting in any way, and therefore should not be construed in that manner.

Network 125 may represent any of a variety of conventional network topologies, which may include any wired and/or wireless network. Network 125 may further utilize any of a variety of conventional network protocols, including public and/or proprietary protocols. For example, network 125 may include the Internet, an intranet, or at least portions of one or more local area networks (LANs).

Data source 130 represents any one of a variety of conventional computing devices, including a desktop personal computer (PC), that is capable of generating 135 code for an application, program, function, or other assemblage of programmable and executable code, any of which is capable of being tested in accordance with various implementations of dynamic marshaling testing 120. Alternatively, data source 130 may also be any one of a workstation, mainframe computer, Internet appliance, set-top box, gaming console, personal digital assistant (PDA), laptop computer, cellular telephone, etc., that is capable of transmitting at least a portion of an application, program, or function to another work station. Further, code, which may or may not be object-oriented code, from data source 130 may be transmitted from data source 130 to any of devices 105, 110, and 115 as part of an on-line notification via network 125 or as part of an off-line notification.

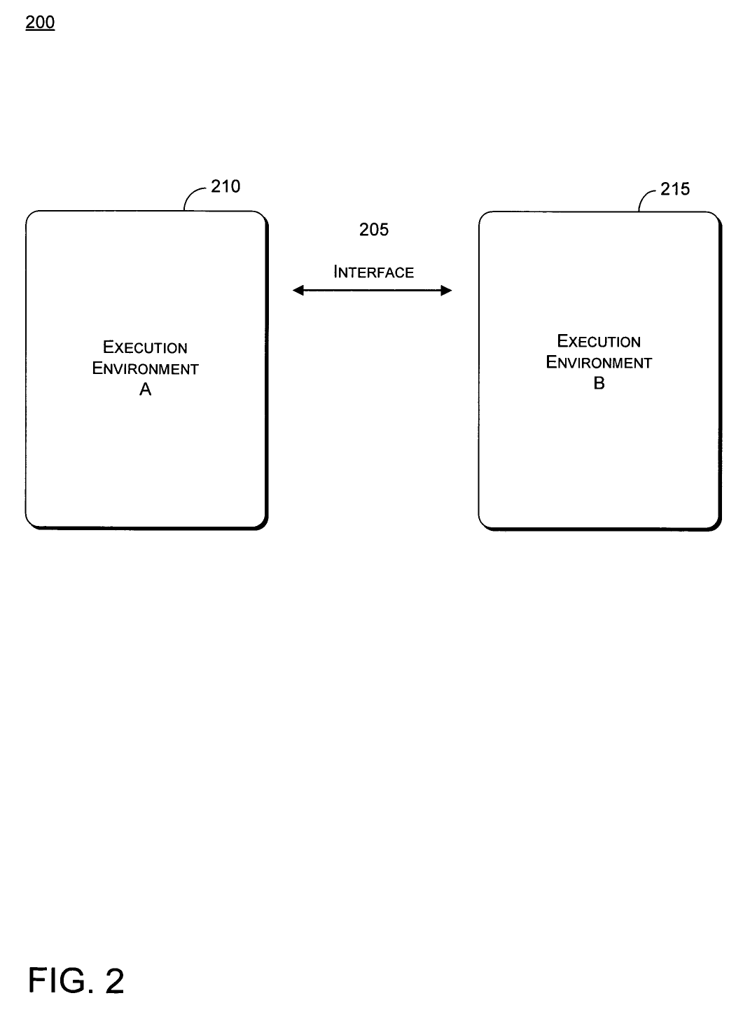

FIG. 2 provides an overview of testing environment 200 for implementing examples of dynamic marshaling testing. More particularly, FIG. 2 illustrates that implementations of dynamic marshaling testing may be utilized to test interoperability between different types of execution environments. For the purpose of describing example implementations of dynamic marshaling testing 120, execution environment A 210 may be a managed execution environment and execution environment B 215 may be an unmanaged execution environment.

Interface 205 may refer to the interoperability between execution environment A 210 and execution environment B 215. That is, interface 205 may refer to the ability of data to be marshaled between execution environment A 210 and execution environment B 215, in either direction, in such a manner that the data is readable and executable, as intended, in the different execution environment.

Examples of managed execution environment A 210 may include: Visual Basic runtime execution environment; Java® Virtual Machine runtime execution environment that is used to run, e.g., Java® routines; or Common Language Runtime (CLR) to compile, e.g., Microsoft .NET™ applications into machine language before executing a calling routine.

Managed execution environments may provide routines for application programs to perform properly in an operating system because application programs require another software system in order to execute. Thus, an application program may call one or more managed execution environment routines, which may reside between the application program and the operating system, and the runtime execution environment routines may call the appropriate operating system routines.

Managed execution environments have been developed to enhance the reliability of software execution on a growing range of processing devices including servers, desktop computers, laptop computers, and a host of mobile processing devices. Managed execution environments may provide a layer of abstraction and services to an application program running on a processing device, and further provide such an application program with capabilities including error handling and automatic memory management.

Accordingly, unmanaged execution environment 215 may refer to application programs as they are viewed by an operating system. That is, unmanaged execution environment 215 may refer to an application program outside of managed execution environment 210.

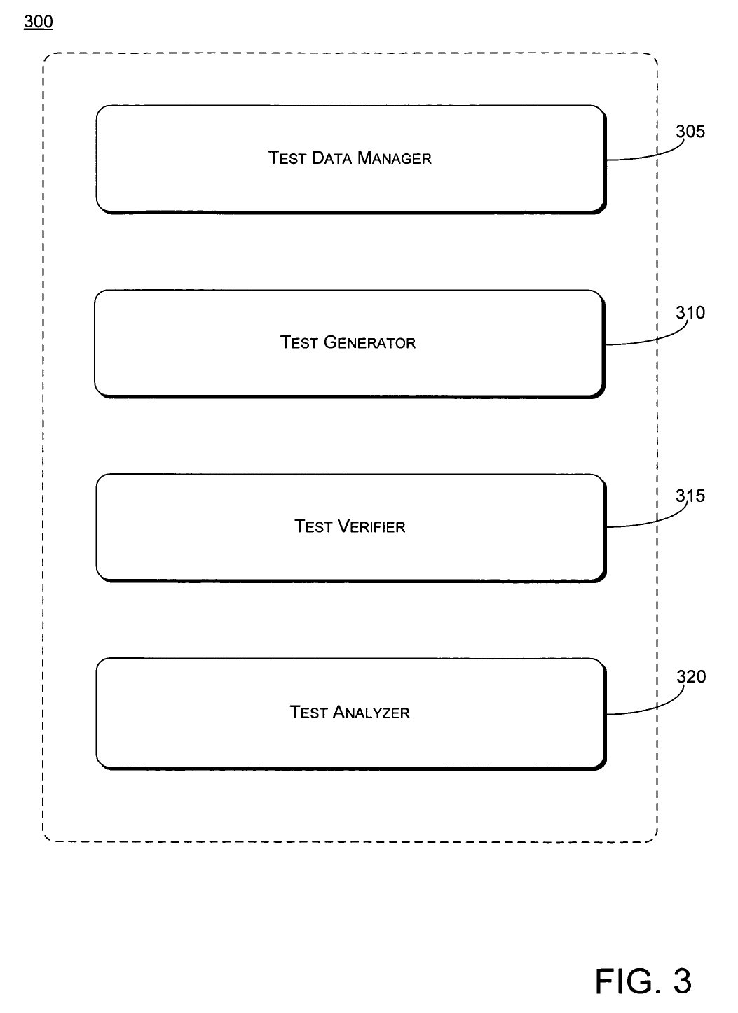

FIG. 3 shows an example of marshaler 300 in accordance with one or more implementations of dynamic marshaling testing. Marshaler 300 may generate test cases to test interface 205 based on a test matrix using one of various code generating techniques. Depending upon test requirements for interface 205, marshaler 300 may be disposed in accordance with either of execution environment A 210 or execution environment B 215. However, for the purpose of describing example implementations of dynamic marshaling testing 120, marshaler 300 is hereafter described as corresponding to managed execution environment A 210.

Further, in the following description of marshaler 300, various operations will be described as being performed by components including test data manager 305, test generator 310, test verifier 315, and test analyzer 320. The various operations that are described with respect to a particular one of the aforementioned components may be carried out by the particular component itself, or by the component in cooperation with one or more of the other components. Further, the operations of the components 305, 310, 315, and 320 may be implemented as hardware, firmware, or some combination thereof.

Test data manager 305 may capture and store test information, particularly information pertaining to a testing scenario for which interface 205 (see FIG. 2) is to be tested. Such test information may be captured by manager 305 via a graphic user interface (GUI; not shown) corresponding to marshaler 300 or via command line arguments as marshaler 300 is in console mode. The test information for both of the aforementioned example implementations of manager 305 capturing test information. may be provided by user intervention or by an automated process. Further, the test information captured by manager 305 may be stored in internal data structures of manager 305 so as to be utilized by other components of marshaler 300.

The test information (i.e., parameters) for testing interface 205 may be randomly set for each test case. That is, in order to test interface 205, multiple permutations of testing parameters may be assembled by marshaler 300 as a matrix of testing parameters is captured and stored by manager 305. For each of the test cases (i.e., assemblies), the parameters may be randomly set.

The parameters may or may not be particular for a marshaling direction (i.e., either managed execution environment A 210-to-unmanaged execution environment B 215; or vice-versa). It is noted that the parameters described below are described utilizing sample nomenclature that may be changed or modified, and such nomenclature is not intended to be limiting in any manner. Non-limiting examples of such parameters indicate:
marshaling direction;
number of scenarios (i.e., monitoring a number of generated test cases);
type of interaction (e.g,, as a flat API call, also known as “Plnvoke” or as a COM (component object model) Interop);
threading model;
API name;
number of method parameters;
data type for each method parameter (i.e., the static type and the instance type);
name of each method parameter;
initial value of each method parameter;
final value of each method parameter;
whether ByRef=true/false for each method parameter;
whether IsIn=true/false for each method parameter;
whether IsLCIDParameter=true/false for each method parameter;
whether IsOptional=true/false for each method parameter;
whether IsOut=true/false for each method parameter;
whether to put a MarshalAsAttribute on each data type;
method return type (i.e., either a static type or instance type);
expected return value;
whether best-fit mapping is enabled;
character set (e.g., Ansi, Unicode, Auto);
COM-visibility (which may pertain only to a managed execution environment);
DLL (dynamic link library) name;
entry point name (which may be different from the API name);
whether ExactSpelling is set to true or false (specific to Plnvoke);
LCID conversion (whether (and therefore, where) an LCID parameter should exist;
calling convention;
visibility (e.g., public, private, family, assembly, FamOrAssembly, FamAndAssembly);
whether PreserveSig is enabled;
whether SetLastError is enabled; and
whether unmanaged code security is suppressed

Furthermore, when a data type is an array, more parameters are possible, non-limiting examples of which include:
array dimensions;
a size of each array dimension;
a number of actual elements in each array dimension, a data type of each element, values for such elements, etc.;

Further still, when a data type is one of a class, enumeration, structure, interface, or delegate, more parameters are possible. Non-limiting examples of such further parameters include:
type name; and
whether the type is user-defined, therefore requiring generation, or if the type is included within an existing class in a standard library.

Test generator 310 may utilize the test information captured and stored by manager 305 to dynamically generate test cases (i.e., assemblies) for testing interface 205 between execution environment A 210 and execution environment B 215. Further, such dynamic test case generation may be recursive in nature. For instance, at least one of the parameters described above may be a delegate having corresponding parameters itself; at least one of the further parameters may be a structure having several fields; and one of such fields may be a delegate.

Test generator 310 may utilize known dynamic code generating implementations for either of a managed execution environment or an unmanaged execution environment depending, obviously, upon the direction of the dynamic marshaling testing. An example of such dynamic code generating in managed execution environment A 210 (FIG. 2) includes, but is in no way limited to, Reflection.Emit, which is particular to CLR, which may be utilized to generate (i.e., assemble) intermediate language.

As part of dynamically generating the test cases based on the test matrix captured and stored by manager 305, test generator 310 may further generate one or more callback methods to be utilized in testing interface 205 (FIG. 2). More particularly, test generator 310 may generate a method description callback method to indicate a number of parameters, a desired stack size, and a calling convention for a particular one of the generated test cases; and a method implementation callback method to provide a native view of the stack. The aforementioned callback methods, either singularly or in combination therewith, may be included as part of “glue code” in an executable test case. “Glue code” may be regarded as code that may be common to substantially all test cases generated by marshaler 300.

The method description callback method may be provided to indicate, to a target of a corresponding test case, a number of arguments included in the test case, a stack size required for the test case, and a calling convention for the test case. Alternative examples of the method description callback method may be utilized to indicate further information regarding the parameters of the test case. Regardless, the method description callback method may provide at least the parameters necessary for a target object in the different execution environment to simulate the scenario for the particular test case.

The method implementation callback method may be provided to indicate a native view of the stack in the different execution environment, in accordance with a particular one of the generated test cases. That is, the method implementation callback method may enable a target object in the different execution environment to enable verification that marshaling of a particular test case was executed correctly.

Further, the method implementation callback method may include code to enable the generated test case to check (i.e., verify) a return value from the target object in the different execution environment and, thus, perform error checking. Even further, the method implementation callback method may include data to indicate a particular technique required to implement the aforementioned verification and error checking. That is, since method invocation and processor state may be handled differently for different processor architectures, the method implementation callback method may include instructions for receiving the return value from the target object in the different execution environment. A non-limiting example of such instructions may include shifting the stack and stack registers by appropriate amounts to enable the reading of specific register information or locations on a current stack in the different execution environment.

Test verifier 315 may utilize a value returned by the method implementation callback method to verify that marshaling for the generated test case has been correctly executed. Thus, according to at least one example implementation, test verifier 315 may be a dll (dynamic link library) to check a value returned from a target object in the different execution environment against an expected value specified in the test matrix captured and stored by test data manager 305. By checking the “value,” the verifier may verify that the state and data associated with the method meet expectations, accomplished by checking return values of the method implementation callback method, values of by-reference parameters, and ensuring that no exceptions are thrown. These implementations for verifying are provided as examples only, and should not be construed to be limiting in any manner.

Test analyzer 320 may be provided by at least one example implementation of marshaler 300 to provide a readable deconstruction of the generated test case, typically in the form of an XML file. Accordingly, test analyzer 320 may lay out, for inspection and/or analysis, information regarding the test case including, but not limited to: scenario type, parameters (including the number of parameters and respective types), return type, and attributes.

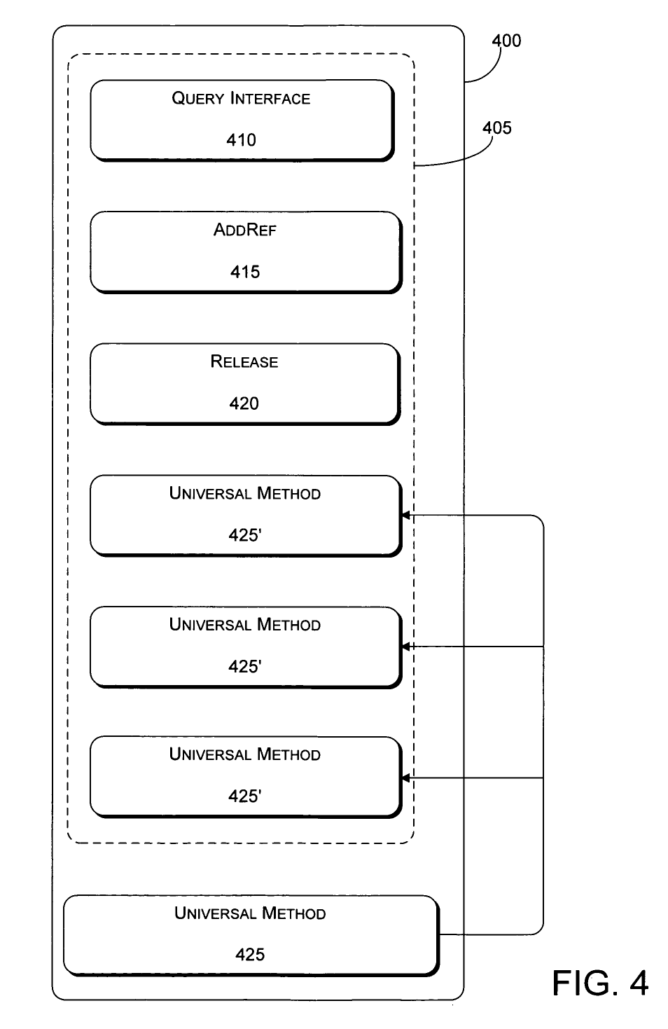

FIG. 4 shows target object 400 against which marshaling from a different execution environment is tested by, e.g., a test case generated in accordance with the description of FIG. 3.

Target object 400 may be a universal COM (UCO) object that is capable of mimicking any COM (component object model) or dll native to different execution environment B 215 (FIG. 2). That is, UCO 400 may be regarded as a standardized object that is benign in terms of actual processing, but is effective as a channeler through which a test case may be provided a processing overview as if actual processing was to occur based on parameters included in the test case. Further, in at least one alternative implementation, UCO 400 may be embodied by more than one component that together purpose to serve as a benign static entry point in the different execution environment.

Typically, COM objects may be called by binding to a virtual function table (i.e., vtable) slot on a COM interface. To mimic any COM interface, UCO 400 returns a COM interface having vtable 405, of which slots 0, 1, and 2, may reference methods of IUnknown. IUnknown is understood to be common for COM objects, and comprise QueryInterface 410, AddRef 415, and Release 420.

The remaining slots of vtable 405 reference a static export that may be referred to as the UniversalMethod 425, which enables UCO 400 to expose COM interfaces or static dll exports. vtable 405 is shown as having multiple slots, the number of which is specified by the parameters of the test case, that call instances of UniversalMethod 425′.

UniversalMethod 425 may be regarded as a static export that typically has the same name (i.e., UniversalMethod) and a same ordinal. However, a corresponding signature may differ for one COM object to another. Accordingly, the execution environment for marshaler 300 (FIG. 3) may bind any signature to an arbitrary method name. An example of such would be a managed execution environment (e.g., CLR) binding a signature to a method name in C# syntax.

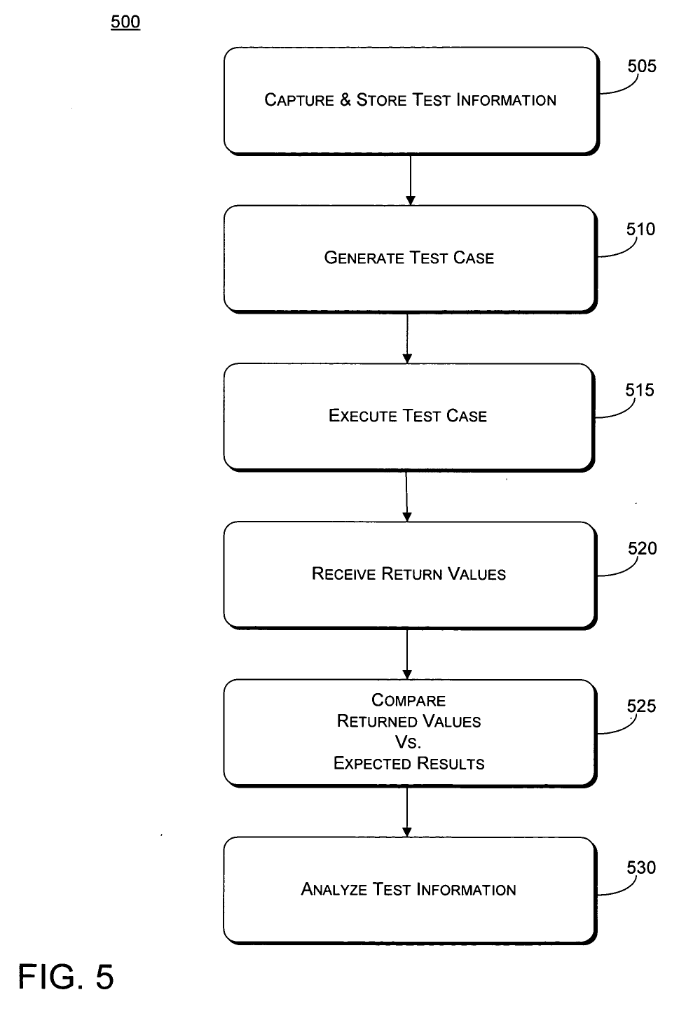

FIG. 5 shows example processing flow 500 associated with dynamic marshaling testing implementation with reference to at least some of the features of both FIGS. 3 and 4. More particularly, the example references the testing of interface 205 between marshaler 300 in managed execution environment A 210 and COM object 400 in unmanaged execution environment B 215 (FIG. 2). However, it is understood that depending upon various permutations of parameters in the testing information, processing flow 500 may have further application in the opposite marshaling direction.

Block 505 may represent the capture and store of test information by test data manager 305 of marshaler 300.

Block 510 may represent the random generation of at least one test case by test generator 310. More particularly, the captured test information may be used to dynamically generate test cases (i.e., assemblies) for testing interoperability between two different execution environments. The test case may be generated using known dynamic code generating implementations for either of a managed execution environment or an unmanaged execution environment depending upon the direction of the dynamic marshaling testing as specified in the captured test information.

Further, included in the test case are one or more generated callback methods. The first callback method may provide a COM object 400 with information regarding the parameters of the test case. The second callback method may provide a view of the stack from the perspective of the different execution environment.

Block 515 may refer to the dynamically generated test case being executed by marshaler 300, typically via test generator 310, to COM object 400 in unmanaged execution environment B 215.

Block 520 may refer to return values being received by marshaler 300, typically by test verifier 315. The return values may include a native view of the stack in unmanaged execution environment B 215.

More specifically, in order to return a value in the appropriate state, UniversalMethod 425 on COM object 400 receives, at least, the number of arguments being passed thereto by the test case, the stack size required by the test case, and the calling convention of the test case. Such parameters are indicated by the method description callback method. To plug in an arbitrary implementation into a simulated method in unmanaged execution environment B 215, UniversalMethod 425 utilizes the method implementation callback method to provide the test case with a view of the unmanaged stack.

Block 525 may refer to test verifier 315 checking the returned value against an expected value specified in the test matrix captured and stored by test data manager 305.

Block 530 may refer to test analyzer 320 analyzing the test information by providing a readable deconstruction of the generated test case, typically in the form of an XML file. Thus, information regarding the test case including, but not limited to: scenario type, parameters (including the number of parameters and respective types), return type, and attributes, may be laid out for analysis and/or inspection.

Accordingly, an interoperability between different execution environments may be dynamically tested.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

We claim:

1. A method, comprising:
establishing a scenario for testing an interface with a different execution environment;
generating dynamic test cases, and corresponding expected results, for the testing based on the established scenario;
channeling the test cases to a standardized object in the different execution environment; and
checking values returned from the standardized object against the expected results.

2. A method according to claim 1, wherein the scenario is at least one of a Plnvoke or a COM Interop call.

3. A method according to claim 1, wherein the different execution environment includes an unmanaged execution environment.

4. A method according to claim 1, wherein at least one of the test cases includes a callback method to indicate, at least, a number of arguments in the test case, a stack size required for the test case, and a calling convention for the test case.

5. A method according to claim 1, wherein at least one of the test cases includes a callback method to indicate, at least, a view of a stack in the different execution environment, per the established scenario for the generated test case.

6. A method according to claim 1, wherein the standardized object is a COM (Component Object Model) object.

7. A system, comprising:
a test generator to dynamically generate a test case for testing marshaling against a target object in a different execution environment;
a verifier to verify compare a value returned from the target against an expected result for the test case; and
a test analyzer to provide a readable deconstruction of the test case.

8. A system according to claim 7, wherein the test generator is to dynamically generate a test case that includes a callback method to inform the target object of a quantity and size of parameters corresponding to the test case.

9. A system according to claim 7, wherein the test generator is to dynamically generate a test case that includes a callback method to inform the target object of, at least, a number of arguments corresponding to the test case, a stack size required by the test case, and a calling convention corresponding to the test case.

10. A system according to claim 7, wherein the test generator is to dynamically generate a test case that includes a callback method to provide a view of a stack in an execution environment corresponding to the target object.

11. A system according to claim 7, wherein the test case scenario is at least one of a Plnvoke or a COM Interop call.

12. A system according to claim 7, wherein the different execution environment is an unmanaged execution environment.

13. A system according to claim 7, wherein the target object is a COM object.

14. A system according to claim 7, wherein the target object is a DLL (dynamic link library) export.

15. A computer-readable medium having executable instructions that, when read, cause one or more processors to:
generate a test matrix for testing marshaling against a target object in a different execution environment;
a verifier to verify compare a value returned from the target against expected results for the test matrix; and
a test analyzer to provide a readable deconstruction of the test matrix.

16. A computer-readable medium according to claim 15, wherein the test matrix includes permutations based on, at least:
marshaling types;
argument quantities;
argument combinations;
call types; and
scenario attributes.

17. A computer-readable medium according to claim 15, wherein, for an case in the test matrix, the case includes a callback method to indicate, at least, a number of arguments in the case, a stack size required for the case, and a calling convention for the case.

18. A computer-readable medium according to claim 15, wherein at least one case in the test matrix includes a callback method to indicate, at least, a view of a stack required for the case in the different type of execution environment.

19. A computer-readable medium according to claim 15, wherein the target object includes a COM object.

20. A computer-readable medium according to claim 15, wherein the target object includes a DLL export.
